(19) United States
(12) Patent Application Publication
(10) Pub. No.: US 2026/0247041 A1
(43) Pub. Date: Aug. 20, 2026

(54) IMAGE PROCESSING APPARATUS THAT PROCESSES IMAGES CAPTURED BY SPLIT EXPOSURE, IMAGE CAPTURING APPARATUS, CONTROL METHOD, AND STORAGE MEDIUM

(71) Applicant: CANON KABUSHIKI KAISHA, Tokyo (JP)

(72) Inventor: TAKAO SASAKI, Kanagawa (JP)

(21) Appl. No.: 19/444,573

(22) Filed: Jan. 9, 2026

(30) Foreign Application Priority Data
Feb. 17, 2025 (JP) 2025-023349

(51) Int. Cl. H04N 23/76; G06T 5/50; H04N 23/81

(52) U.S. Cl. CPC H04N 23/76; G06T 5/50; H04N 23/81; G06T 2207/20216

(57) ABSTRACT

An image processing apparatus that performs image processing on a plurality of images acquired by split exposure. Predetermined areas in the plurality of images are extracted, and a combined image is generated using the predetermined areas. Saturated areas and unsaturated areas in the plurality of images are extracted, and a saturated area combined image is generated by using the saturated areas and an unsaturated area combined image is generated by using the unsaturated areas. The saturated area combined image and the unsaturated area combined image are combined.

### BACKGROUND

### Field of the Technology

The present disclosure relates to an image processing apparatus that processes images captured by split exposure, an image capturing apparatus, a control method and a storage medium.

### Description of the Related Art

Japanese Laid-Open Patent Publication (Kokai) No. 2015-136087 discloses a technique for suppressing, by combining a plurality of images captured by split exposure without attaching a physical neutral density (ND) filter, occurrence of overexposure or the like, as suppressed by the physical ND filter. Further, in a case where pixel values of one area in an image captured by split exposure are saturated, a phenomenon is sometimes generated in which in a combined image after being averaged, hue deviation occurs and luminance is lowered in an area corresponding to the one area. Japanese Laid-Open Patent Publication (Kokai) No. 2023-141237 discloses a technique for suppressing the above-mentioned hue deviation and lowering of luminance.

However, in a case where pixels in one area in an image captured by split exposure are saturated, even though it is possible to suppress such phenomenon, as hue deviation and lowering of luminance, which occurs in an averaged image, this problem has not been fundamentally solved in the present state.

### SUMMARY

The present disclosure is directed to providing an image processing apparatus that is capable of preventing hue deviation, lowering of luminance, and so forth, even in a case where pixels in a specific area in an image captured by split exposure are saturated, an image capturing apparatus, a control method, and a storage medium.

According to a first aspect of the embodiments, there is provided an image processing apparatus that performs image processing on a plurality of images acquired by split exposure, including at least one processor, and a memory storing instructions that, when executed by the at least one processor, cause the at least one processor to function as an extraction unit configured to extract predetermined areas in the plurality of images, and a combining unit configured to generate a combined image using the extracted areas, wherein the extraction unit extracts saturated areas and unsaturated areas in the plurality of images, and wherein the combining unit generates a saturated area combined image by using the saturated areas and generates an unsaturated area combined image by using the unsaturated areas, and combines the saturated area combined image and the unsaturated area combined image.

According to a second aspect of the embodiments, there is provided a method of controlling an image processing apparatus, including extracting predetermined areas in a plurality of images captured by split exposure, and generating a combined image using the extracted areas, wherein the extracting includes extracting saturated areas and unsaturated areas in the plurality of images, and wherein the combining includes generating a saturated area combined image by using the saturated areas and generating an unsaturated area combined image by using the unsaturated areas, and combining the saturated area combined image and the unsaturated area combined image.

Features of the present disclosure will become apparent from the following description of embodiments with reference to the attached drawings. The following description of embodiments are described by way of example.

### BRIEF DESCRIPTION OF THE DRAWINGS

FIG. 1 is a configuration diagram of an image capturing apparatus according to embodiments of the present disclosure.

FIG. 2 is a flowchart of an image combining process according to a first embodiment of the present disclosure.

FIG. 3 is a flowchart of an image combining process according to a second embodiment of the present disclosure.

FIGS. 4A to 4G are diagrams useful in explaining split exposure and image combination.

FIGS. 5A to 5E are diagrams useful in explaining combined images in the present disclosure.

### DESCRIPTION OF THE EMBODIMENTS

The present disclosure will now be described in detail below with reference to the accompanying drawings showing embodiments thereof. Configurations described in the following embodiments are given only by way of example, and are by no means intended to limit the scope of the present disclosure.

The present disclosure obtains, when split exposure is performed, by adjusting, through adjustment of ISO or the like, the brightness to a brightness in a case where split exposure is not performed, and performing combining average-combining in combination, to thereby obtain the same effects as a slow shutter effect obtained by ND filter.

Further, a saturated area is an area in which the luminance becomes a predetermined value or higher to cause a problem (such as overexposure), and an unsaturated area is an area in which the luminance is lower than a predetermined value to cause no problem. Both of the saturated area and the unsaturated area are images extracted from a captured image. Further, an image generated by combining saturated areas of a plurality of images is referred to as a saturated area combined image, and similarly, an image generated by combining unsaturated areas of the plurality of images is referred to as an unsaturated area combined image.

Further, split exposure refers to processing for continuously performing photographing during an exposure period. According to the present disclosure, when split exposure is performed, the same effect as the slow shutter effect obtained by the ND filter is obtained by adjusting, through adjustment of ISO or the like, the brightness to a brightness in a case where split exposure is not performed and performing average-combining in combination.

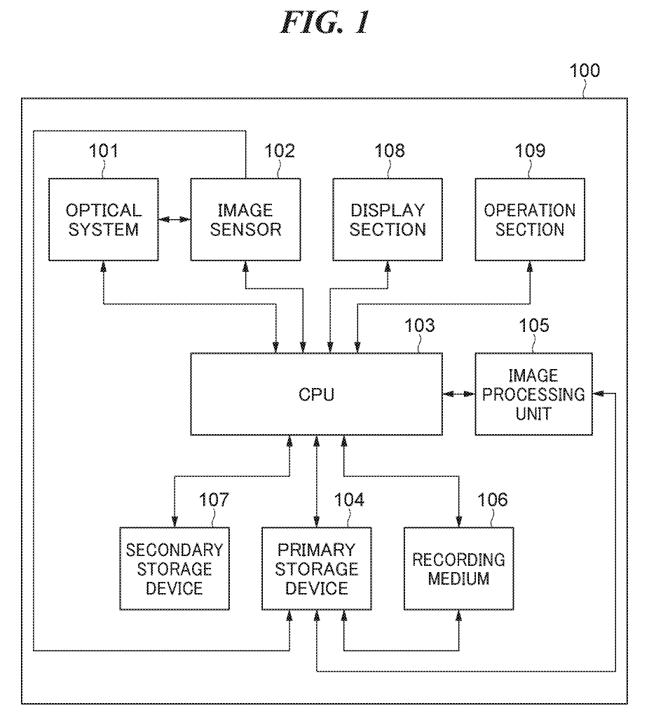

FIG. 1 is a block diagram showing a basic configuration of an image capturing apparatus 100 including an image processing unit of embodiments according to the present disclosure. As the image capturing apparatus 100, an image capturing device, such as a digital camera and a digital video camera, can be used. Further, the image capturing apparatus 100 can be an electronic device having a camera function, such as a mobile phone with the camera function and a computer with the camera function.

The image capturing apparatus 100 includes an optical system 101, an image sensor 102, a central processing unit (CPU) 103, a display section 108, an operation section 109, an image processing unit 105, a primary storage device 104, and a secondary storage device 107. The image capturing apparatus 100 is configured such that a recording medium 106 can be removably attached thereto.

The optical system 101 is configured to include a lens, a shutter, a diaphragm, and so forth. The optical system 101 causes an object image to be formed on the image sensor 102. The image sensor 102 photoelectrically converts the object image formed thereon and outputs image capturing signals (captured image). The image sensor 102 is realized e.g. by a charge coupled device (CCD) image sensor, a complementary metal-oxide-semiconductor (CMOS) image sensor, or the like.

The CPU 103 controls the components of the image capturing apparatus 100 by executing programs stored in advance. The primary storage device 104 is a volatile storage device, such as a random access memory (RAM). The primary storage device 104 has a work area formed therein for the CPU 103 and stores temporary data when the CPU 103 executes a program. Further, the primary storage device 104 can also store image data on which the image processing unit 105 performs a variety of image processing operations and image data to be stored in the attached recording medium 106.

The secondary storage device 107 is a nonvolatile storage device, such as an electrically erasable programmable read-only memory (EEPROM) and a flash memory. The secondary storage device 107 stores a program (firmware) for controlling the image capturing apparatus 100, a variety of pieces of setting information set by a user operating the operation section 109, and so forth. The CPU 103 reads out storage contents stored in the secondary storage device 107 and writes data into the secondary storage device 107.

The display section 108 displays a variety of pieces of information. The display section 108 is realized by a liquid crystal device, an electroluminescent (EL) device or the like. As the variety of pieces of information displayed by the display section 108, a viewfinder image during image capturing, a captured image, a GUI image which enables an interactive operation, and so forth are displayed. The operation section 109 is an input device group that receives an operation from a user and transmits a signal corresponding to the received operation to the CPU 103. The operation section 109 is realized by operation members, such as a button, a lever, and a touch panel. The operation section 109 can be configured to be capable of receiving a variety of operations by using a voice, a line of sight, and/or the like.

The recording medium 106 records e.g. captured image data stored in the primary storage device 104. The recording medium 106 is a recording device which can be removably attached to the image capturing apparatus 100, such as a semiconductor memory card and a USB memory. The recording medium 106 storing image data and the like can be attached to an electronic apparatus, such as a personal computer (PC), as another apparatus. Therefore, the image data of images captured by the image capturing apparatus 100 and the like are read and stored in the other electronic apparatus to which the recording medium 106 is attached. Thus, the image capturing apparatus 100 has a mechanism for attaching/removing the recording medium 106 and a reading/writing function.

The image processing unit 105 is capable of performing a plurality of types of image processing on the image capturing signals (captured image) output from the image sensor 102. The user can perform an operation of setting an image capturing mode by operating the operation section 109, and the image processing unit 105 executes a variety of image processing operations according to the set image capturing mode.

The image processing unit 105 performs not only the image processing referred to as the development processing, but also a variety of image processing operations, such as color adjustment according to an image capturing mode, on a captured image. Further, some or all of the functions included in the image processing unit 105 can be realized by the CPU 103 executing an image processing program. The some or all of the functions included in the image processing unit 105 can be realized by hardware, such as an ASIC circuit.

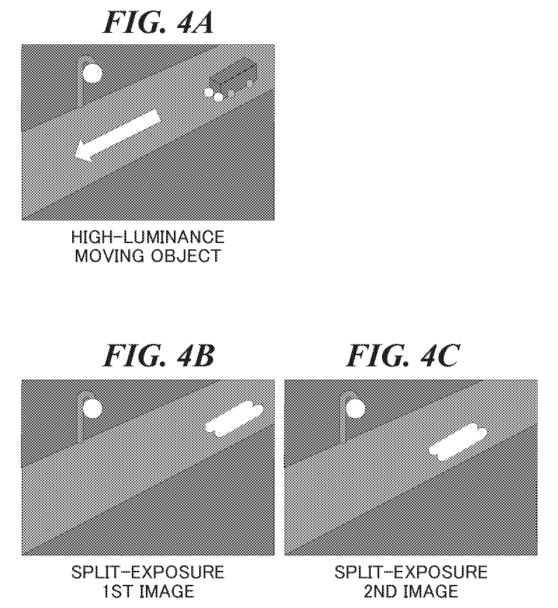

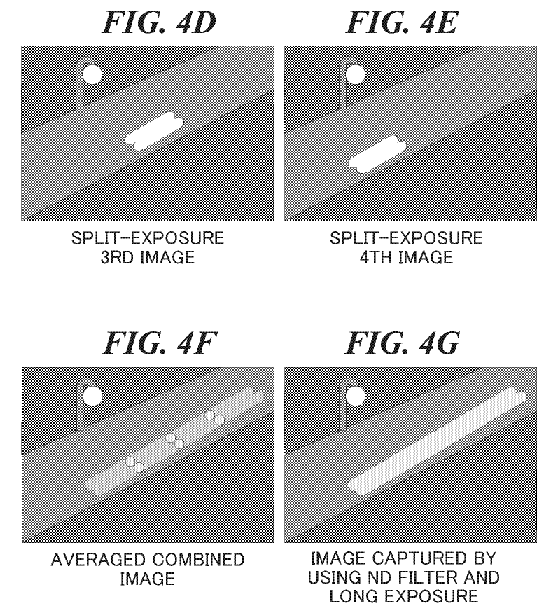

FIGS. 4A to 4G are diagrams useful in explaining conventional examples of split exposure and image combination. FIGS. 4A to 4G are explanatory diagrams of an example of suppression of overexposure and the like by split exposure, as performed by the physical ND filter. In FIGS. 4A to 4G, image capturing of a vehicle (high-luminance moving object) is assumed, by way of example.

As shown in FIG. 4A, in a case where a high-luminance moving object, such as a vehicle using headlights, is captured by split exposure, each image is captured as shown in FIGS. 4B to 4E. Further, FIG. 4G shows an image captured in a case where long-exposure image capturing (image capturing over a long exposure time) using the ND filter is performed.

In a case where the images shown in FIGS. 4B to 4E are averaged and combined, as shown in FIG. 4F, hue deviation and lowering of luminance occur with respect to the locus of the high-luminance moving object. This is caused by a reason that, originally, long-exposure image capturing corresponds to execution of addition combining of images, but in a case where image capturing is performed by split exposure, a combined image is obtained by executing average combining in which images are added and averaged.

Therefore, there is a problem that the saturated areas and the unsaturated areas are averaged by performing average combining, whereby the luminance becomes lower than the actual luminance. Note that although FIGS. 4B to 4E shows the example in which split exposure is realized by four captured images, the above-described problem occurs without limiting the number of captured images to four.

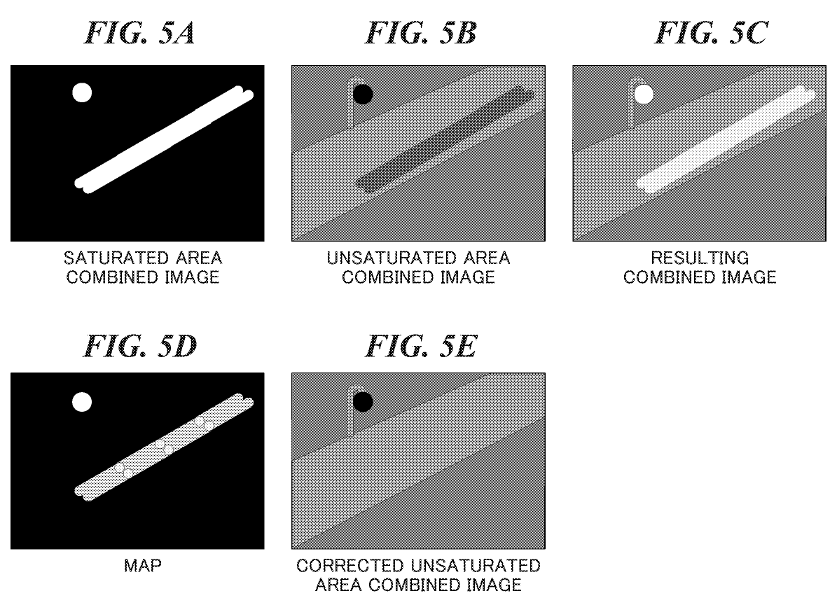

To solve this problem, in the embodiments according to the present disclosure, a combined image of the saturated areas and a combined image of the unsaturated areas are generated, respectively. Then, attention is focused on combining the combined image of the saturated areas and the combined image of the unsaturated areas, to thereby eliminate breaks in the locus of the high-luminance moving object (see FIGS. 5A to 5E).

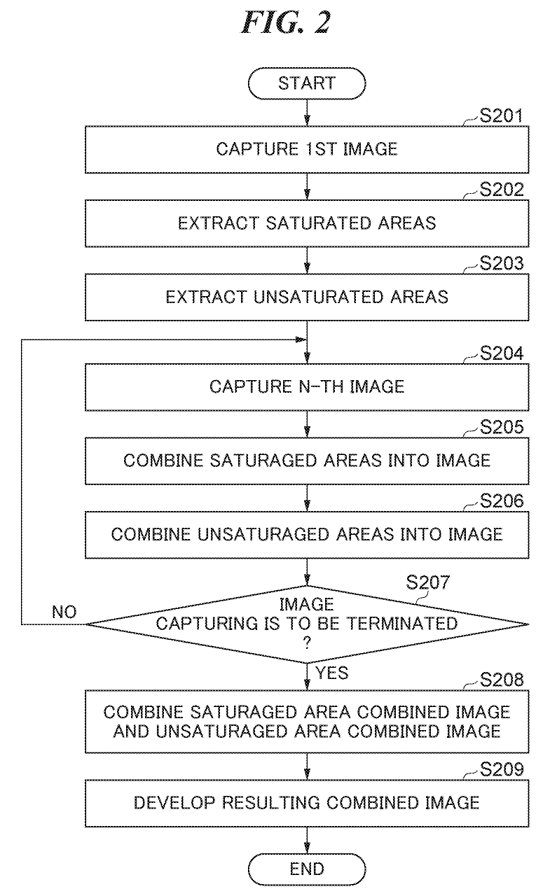

FIG. 2 is a flowchart of an image combining process according to a first embodiment of the present disclosure. The first embodiment will be described with reference to FIG. 2. The following description assumes image capturing by split exposure.

First, in a step S201, the CPU 103 controls the image capturing apparatus 100 to execute image capturing of a first image and sends the captured image to the image processing unit 105. Next, in a step S202, the image processing unit 105 extracts saturated areas in the first captured image and stores the extracted saturated areas in the primary storage device 104. Next, in a step S203, the image processing unit 105 extracts unsaturated areas in the first captured image and stores the extracted unsaturated areas in the primary storage device 104. Then, the image processing unit 105 executes the same processing operations in the steps S201 to S203 on the second to N-1-th captured images.

Next, in a step S204, the CPU 103 executes image capturing of an N-th image and sends the captured image to the image processing unit 105. The image processing unit 105 extracts the saturated areas and unsaturated areas in the N-th captured image and stores the extracted saturated areas and unsaturated areas in the primary storage device 104. With these image processing operations up to this step, the saturated areas and the unsaturated areas in each of the plurality of captured images are extracted.

Next, in a step S205, the image processing unit 105 combines the saturated areas in the first to N-1-th captured images and the saturated areas of the N-th captured image into an image. More specifically, the image processing unit 105 reads out the saturated areas extracted from the first to N-th images from the primary storage device 104 and combines the images of the saturated areas. As a result of this combining processing, a saturated area combined image is generated. Further, as the method of combining the saturated areas, any combining form can be used insofar as it is a method that prevents occurrence of hue deviation and lowering of luminance in the saturated areas (see FIG. 5A). For example, there is not only average combining of the saturated areas, but also a method of lighten-only combining. The lighten-only combining is a method in which two images are compared on a pixel-by-pixel basis, and pixels each having the higher luminance are combined.

Next, in a step S206, the image processing unit 105 combines the unsaturated areas in the first to N-1-th captured images and the unsaturated areas of the N-th captured image into an image (see FIG. 5B). More specifically, the image processing unit 105 reads out the unsaturated areas extracted from the first to N-th images from the primary storage device 104 and combines the unsaturated areas of the captured images. As a result of this combining processing, an unsaturated area combined image is generated. As the combining form, similar to the step S205, the average combining and the lighten-only combining can be used.

In a step S207, the CPU 103 determines whether or not to terminate image capturing. If it is determined by the CPU 103 that image capturing is to be terminated (YES), the process proceeds to a step S208, whereas if it is determined by the CPU 103 that image capturing is not to be terminated (NO), the process returns to the step S204. That is, the CPU 103 repeats the processing operations until the image processing unit 105 terminates image combining of the saturated areas in the first to N-th captured images and image combining of the unsaturated areas in the first to N-th captured images, and when the processing operations are completed, the process proceeds to the step S208.

Next, in the step S208, the image processing unit 105 combines the saturated area combined image obtained in the step S205 and the unsaturated area combined image obtained in the step S206 (see FIG. 5C). Then, in a step S209, the image processing unit 105 develops the combined image obtained in the step S208.

By generating the combined image of the saturated areas and the combined image of the unsaturated areas, and combining both of the generated combined images as described in the first embodiment, it is possible to suppress e.g. overexposure, as suppressed by the physical ND filter, and prevent hue deviation and lowering of luminance, caused by split exposure.

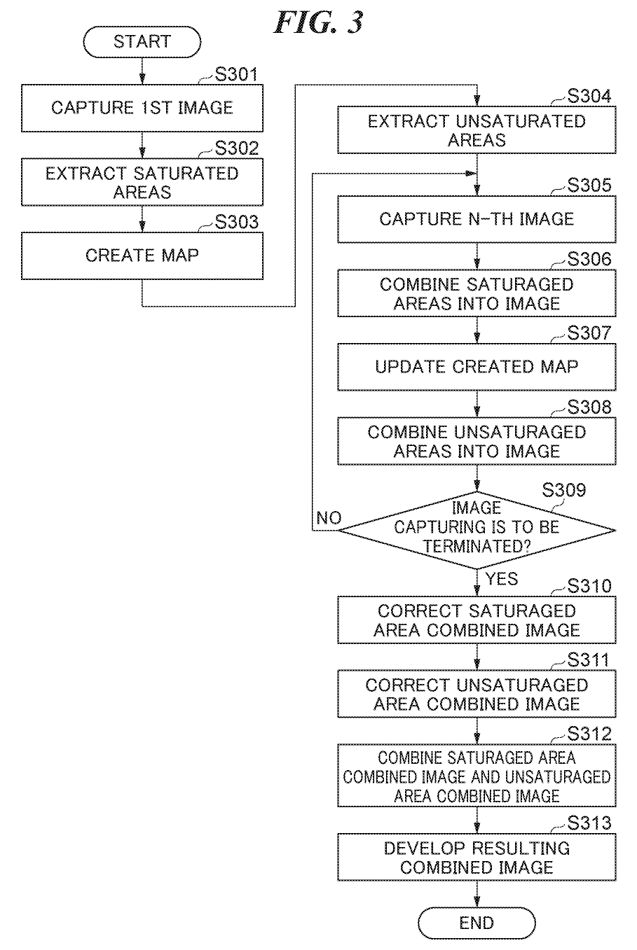

A second embodiment according to the present disclosure will be described below with reference to FIG. 3. The second embodiment is characterized in that a map is generated in addition to the combining processing in the first embodiment, and the saturated area combined image and the unsaturated area combined image are corrected by referring to this map. FIG. 3 is a flowchart of a process according to the second embodiment.

First, in a step S301, the CPU 103 controls the image capturing apparatus 100 to execute image capturing of a first image and sends the captured image to the image processing unit 105. Next, in a step S302, the image processing unit 105 extracts saturated areas in a first captured image and stores the extracted saturated areas in the primary storage device 104.

Next, in a step S303, the image processing unit 105 generates a map and stores the map in the primary storage device 104 (see FIG. 5D). This map is formed and stored, by associating an area type, the number of images (the number of images used for image combining) related to a combined image of areas of this area type, and positions of the areas of this area type on the combined image. Here, the area type is information indicating the saturated area or the unsaturated area.

By referring to the map, the image processing unit 105 can grasp the number of images of the saturated areas, used for image combining of the saturated areas, e.g. with respect to a saturated area at a certain location. On the contrary, by referring to the map, the image processing unit 105 can grasp the number of images of the unsaturated areas, used for image combining of unsaturated areas, e.g. with respect to an unsaturated area at a certain location. Next, in a step S304, the image processing unit 105 extracts the unsaturated areas in the first captured image and stores the extracted unsaturated areas in the primary storage device 104. Then, the image processing unit 105 similarly executes the processing operations in the steps S301 to S304 on the second to N-1-th captured images.

Next, in a step S305, the CPU 103 executes image capturing of an N-th image and sends the captured image to the image processing unit 105. The image processing unit 105 extracts the saturated areas in the N-th captured image and stores the extracted saturated areas in the primary storage device 104.

Next, in a step S306, the image processing unit 105 combines the saturated areas in the first to N-1-th captured images and the saturated areas in the N-th captured image into an image. More specifically, the image processing unit 105 reads out the saturated areas extracted from the first to N-th captured images from the primary storage device 104 and combines the images of the saturated areas. As a result, a saturated area combined image is generated. The combining method used in the step S306 will be described when describing saturated area combined image correction in a step S310. Next, in a step S307, the image processing unit 105 updates the contents of the map. For example, in a case where a saturated area in the N-th captured image exists, the image processing unit 105 adds this area to the map.

Next, in a step S308, the image processing unit 105 combines the unsaturated areas in the first to N-1-th captured images and the unsaturated areas in the N-th captured image into an image. As a result, an unsaturated area combined image is generated. More specifically, the image processing unit 105 reads out the unsaturated areas extracted from the first to N-th captured images from the primary storage device 104 and combines the images of the unsaturated areas. The combining method used in the step S308 will be described when describing unsaturated area combined image correction in a step S311.

In a step S309, the CPU 103 determines whether or not to terminate image capturing. If it is determined by the CPU 103 that image capturing is to be terminated (YES), the process proceeds to the step S310, whereas if it is determined by the CPU 103 that image capturing is not to be terminated (NO), the process returns to the step S305. That is, the CPU 103 repeats the processing operations until the image processing unit 105 terminates image combining of the saturated areas in the first to N-th captured images and image combining of the unsaturated areas in the first to N-th captured images, and when the processing operations are completed, the process proceeds to the step S310.

In the step S310, the image processing unit 105 corrects the saturated area combined image obtained in the step S306 to generate a corrected saturated area combined image. For this correction, any method can be used insofar as it is a method that prevents occurrence of hue deviation and lowering of luminance in the saturated area (see FIG. 5E). For example, the image processing unit 105 simply adds the saturated areas in the step S306. Then, the image processing unit 105 corrects the saturated area combined image by acquiring an averaged value of the saturated areas by referring to the contents of the map updated in the step S307.

Further, the method of acquiring an averaged value of each saturated area includes a form in which in a case where, for example, four images are to be captured by split exposure for average combining, when there are only three images of the unsaturated area, 4/3-fold of these unsaturated areas is obtained by multiplying a gain, and the resulting whole is divided by 4. Thus, the image processing unit 105 corrects the unsaturated area combined image on which a predetermined number of images are not combined in combining the unsaturated areas, by referring to the contents stored in the map.

In the step S311, the image processing unit 105 corrects the unsaturated area combined image obtained in the step S308 to generate a corrected unsaturated area combined image. Normally, in a case where the unsaturated areas are simply added and averaged, the luminance at a location including an unsaturated area is lowered as shown in FIG. 5B. This is caused by a reason that since the saturated areas and the unsaturated areas are separately combined, the number of combined unsaturated area images is less than the number of combined saturated area images.

To cope with this, the image processing unit 105 performs average combining of the unsaturated areas extracted in the steps S304 and S308, by way of example. Then, in the step S311, the image processing unit 105 refers to a saturated area number map, and increases images contributing to the unsaturated area combined image by the number of images corresponding to the shortage of the unsaturated areas. As another example, there is a method in which, first, the image processing unit 105 performs only simple average combining of the unsaturated areas in the step S308. Then, the image processing unit 105 refers to the map in the step S311 and generates an averaged image of the unsaturated areas based on the number of the unsaturated area images. With this, it is possible to prevent hue deviation and lowering of luminance, caused due to the number of combined images in combining the unsaturated areas (see FIG. 5E).

Next, in a step S312, the image processing unit 105 combines the “corrected saturated area combined image” obtained and corrected in the step S310 and the “corrected unsaturated area combined image” obtained and corrected in the step S311 (see FIG. 5C). Then, in a step S313, the image processing unit 105 develops the combined image obtained in the step S312.

By combining the saturated area combined image and the unsaturated area combined image and correcting the image generated by combining these images as described in the second embodiment, it is possible to suppress e.g. overexposure as suppressed by the physical ND filter and prevent hue deviation and lowering of luminance, caused by split exposure.

Further, the image processing unit 105 can be configured to perform correction in the step S310 or correction in the step S311. Further, as described above, the image processing unit 105 can be configured to correct the unsaturated area combined image on which the predetermined number of images are not combined in combining the unsaturated areas, by referring to the contents stored in the map.

According to the present disclosure, it is possible to obtain the effect that it is possible to prevent hue deviation, lowering of luminance, and so forth, even in a case where pixels in a specific area in an image captured by split exposure are saturated.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-023349, filed February 17, 2025, which is hereby incorporated by reference herein in its entirety.

What is claimed is:

1. An image processing apparatus that performs image processing on a plurality of images acquired by split exposure, including:
at least one processor; and
a memory storing instructions that, when executed by the at least one processor, cause the at least one processor to function as:
an extraction unit configured to extract predetermined areas in the plurality of images; and
a combining unit configured to generate a combined image using the extracted areas,
wherein the extraction unit extracts saturated areas and unsaturated areas in the plurality of images, and
wherein the combining unit generates a saturated area combined image by using the saturated areas and generates an unsaturated area combined image by using the unsaturated areas, and
combines the saturated area combined image and the unsaturated area combined image.

2. The image processing apparatus according to claim 1, wherein the combining unit generates the saturated area combined image by average-combining or lighten-only combining the saturated areas extracted from the plurality of images.

3. The image processing apparatus according to claim 2, wherein the combining unit generates the unsaturated area combined image by average-combining the unsaturated areas extracted from the plurality of images.

4. The image processing apparatus according to claim 1, wherein the at least one processor is further caused to function as a correction unit configured to perform correction on the saturated area combined image and/or the unsaturated area combined image.

5. The image processing apparatus according to claim 4, wherein the at least one processor is further caused to function as a map generation unit configured to generate a map storing information indicating a saturated area or an unsaturated area and the number of images required to generate the saturated areas, by associating the information and the number with each other, and
wherein the correction unit performs correction on the saturated area combined image and the unsaturated area combined image by referring to the map.

6. The image processing apparatus according to claim 5, wherein the correction unit corrects the unsaturated area combined image in which a predetermined number of images are not combined, by referring to the map.

7. An image capturing apparatus including an image capturing unit, and
an image processing apparatus that performs image processing on a plurality of images acquired by split exposure, including:
at least one processor; and
a memory storing instructions that, when executed by the at least one processor, cause the at least one processor to function as:
an extraction unit configured to extract predetermined areas in the plurality of images; and
a combining unit configured to generate a combined image using the extracted areas,
wherein the extraction unit extracts saturated areas and unsaturated areas in the plurality of images, and
wherein the combining unit generates a saturated area combined image by using the saturated areas and generates an unsaturated area combined image by using the unsaturated areas, and
combines the saturated area combined image and the unsaturated area combined image.

8. A method of controlling an image processing apparatus, comprising:
extracting predetermined areas in a plurality of images captured by split exposure; and
generating a combined image using the extracted areas,
wherein the extracting includes extracting saturated areas and unsaturated areas in the plurality of images, and
wherein the combining includes generating a saturated area combined image by using the saturated areas and generating an unsaturated area combined image by using the unsaturated areas, and
combining the saturated area combined image and the unsaturated area combined image.

9. A non-transitory computer-readable storage medium storing a program for causing a computer to execute a method of controlling an image processing apparatus,
wherein the method comprises:
extracting predetermined areas in a plurality of images captured by split exposure; and
generating a combined image using the extracted areas,
wherein the extracting includes extracting saturated areas and unsaturated areas in the plurality of images, and
wherein the combining includes generating a saturated area combined image by using the saturated areas and generating an unsaturated area combined image by using the unsaturated areas, and
combining the saturated area combined image and the unsaturated area combined image.
